(19) United States
(12) Patent Application Publication
(10) Pub. No.: US 2005/0269165 A1
(43) Pub. Date: Dec. 8, 2005

(54) Brake structure capable of automatically swinging brake block

(76) Inventor: Robert J. Seymour, Epsom (GB)

Correspondence Address: TROXELL LAW OFFICE PLLC;SUITE 1404, 5205 LEESBURG PIKE, FALLS CHURCH, VA, 22041, US

(21) Appl. No.: 10/932,142

(22) Filed: Sep. 2, 2004

(30) Foreign Application Priority Data
Jun. 2, 2004 (GB) 0412241.2

(51) Int. Cl. B62L 1/02

(52) U.S. Cl. 188/24.12

(57) ABSTRACT

A brake structure capable of automatically swinging brake block, including two rocking arms pivotally connected on a bicycle frame, a steel cord and two frictional devices respectively disposed on the rocking arms. One end of the steel cord is connected with a brake lever of the bicycle. The other end of the steel cord is connected with the rocking arms. Each frictional device includes a rod body, a base seat and a brake block. One end of the rod body is disposed on the rocking arm. The other end of the rod body is pivotally connected with one side of the base seat. The brake block is disposed on the other side of the base seat. When pulling the brake lever of the bicycle, the steel cord drives the rocking arms to make the brake blocks contact with the rim. At this time, the brake blocks suffer a force and automatically swing by a certain angle. Accordingly, the brake blocks can always contact with the rim in an optimal mode to achieve better braking effect and prolong using life of the brake blocks.

### BACKGROUND OF THE INVENTION

The present invention is related to a brake device of a bicycle, and more particularly to a brake structure capable of automatically swinging brake block.

The brake device of a bicycle has a first lever mounted on a handle of the bicycle and a second lever (that is, a brake) mounted on the bicycle frame near the rim. A steel cord is connected between the two levers. Via the steel cord, the first lever drives the second lever. The second lever controls a brake block to clamp the rim or not for decelerating or stopping the bicycle.

Referring to FIG. 1, the conventional brake substantially includes two rocking arms 91 and two brake blocks 92 respectively fixedly disposed on the rocking arms. One end of each rocking arm 91 is pivotally connected with the bicycle frame 93. The other end of the rocking arm 91 is connected with the steel cord 94. The steel cord 94 can drive the rocking arms 91 to make the brake blocks 92 contact with the rim 95 or not. The brake blocks 92 are fixedly connected with the rocking arms 91 so that a user needs to cautiously or frequently adjust the angle of the brake blocks 92. Otherwise, the brake blocks 92 can hardly contact with the rim 95 in an optimal state. Accordingly, the braking effect will be deteriorated and the using life of the brake blocks 92 will be shortened.

### SUMMARY OF THE INVENTION

It is therefore a primary object of the present invention to provide a brake structure capable of automatically swinging brake block so as to achieve better braking effect.

It is a further object of the present invention to provide the above brake structure in which the using life of the brake blocks is prolonged.

According to the above objects, the brake structure of the present invention includes two rocking arms pivotally connected on a bicycle frame, a steel cord and two frictional devices respectively disposed on the rocking arms. One end of the steel cord is connected with a brake lever of the bicycle. The other end of the steel cord is connected with the rocking arms. Each frictional device includes a rod body, a base seat and a brake block. One end of the rod body is disposed on the rocking arm. The other end of the rod body is pivotally connected with one side of the base seat. The brake block is disposed on the other side of the base seat.

The present invention can be best understood through the following description and accompanying drawings wherein:

### BRIEF DESCRIPTION OF THE DRAWINGS

FIG. 1 is a side view of a conventional bicycle brake;

FIG. 2 is a side view of a first embodiment of the present invention;

FIG. 3 is a perspective exploded view of the frictional device of the first embodiment of the present invention;

FIG. 4 is a perspective assembled view of the frictional device of the first embodiment of the present invention;

FIG. 5 is a perspective exploded view of the rod body and the base seat of a second embodiment of the present invention;

FIG. 6 is a perspective exploded view of the rod body and the base seat of a third embodiment of the present invention;

FIG. 7 is a perspective exploded view of the rod body and the base seat of a fourth embodiment of the present invention;

FIG. 8 is a perspective exploded view of the rod body and the base seat of a fifth embodiment of the present invention;

FIG. 9 is a sectional view taken along line I-I of FIG. 8; and

FIG. 10 is a sectional view taken along line II-II of FIG. 8.

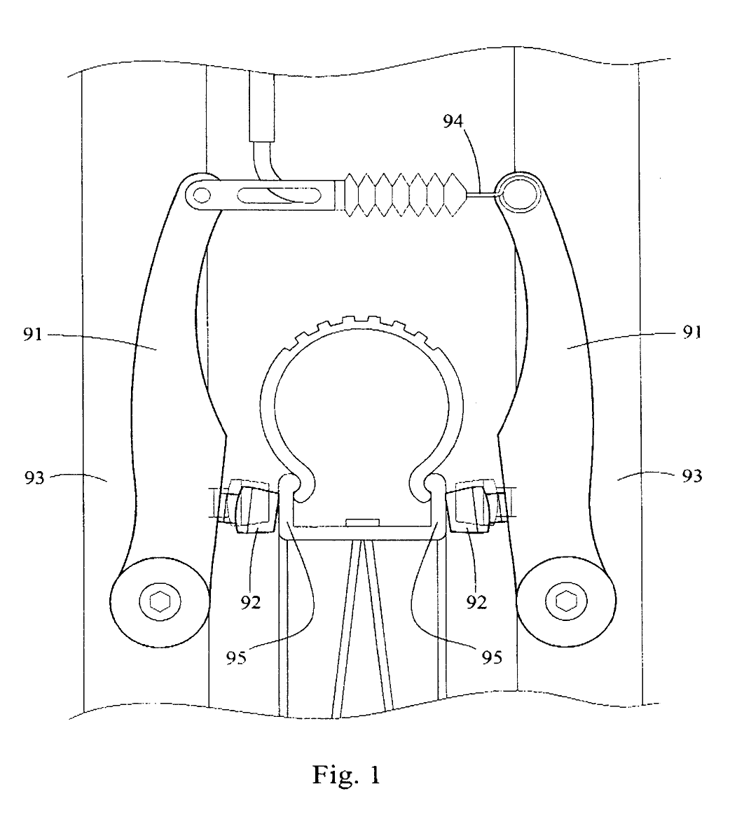

### DETAILED DESCRIPTION OF THE PREFERRED EMBODIMENTS

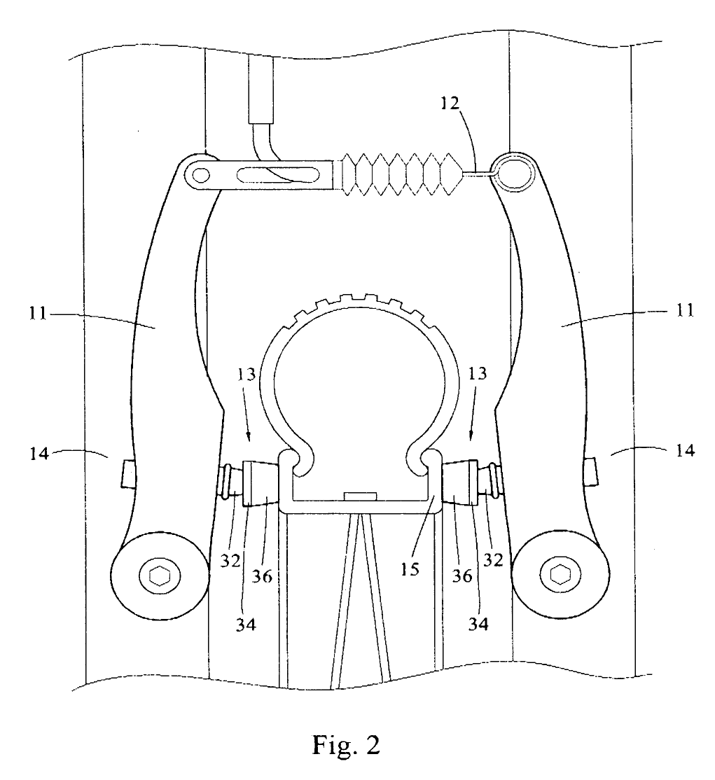

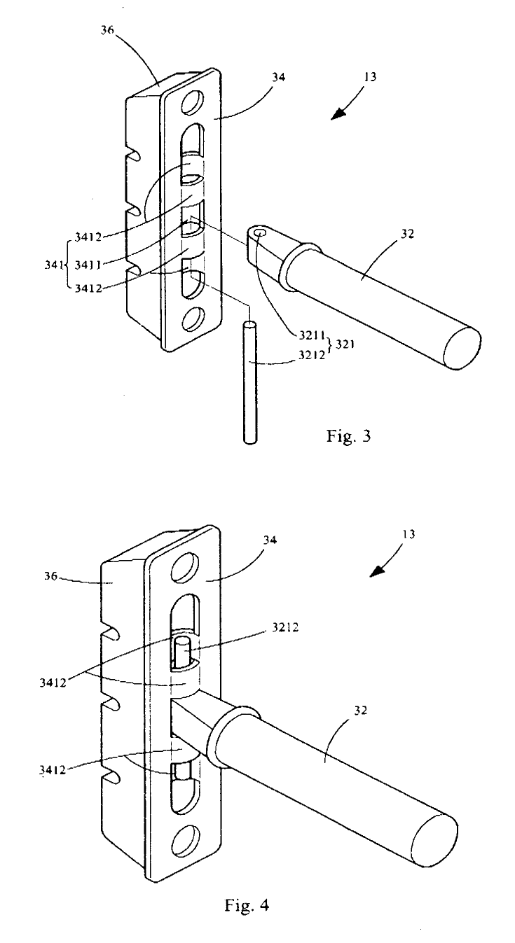

Please refer to FIGS. 2 to 4. The brake structure of the present invention includes two rocking arms 11, a steel cord 12 and two frictional devices 13 respectively disposed on the rocking arms 11.

One end of each rocking arm 11 is pivotally connected on a bicycle frame 14. The two rocking arms 11 are oppositely positioned on two sides of a rim 15 of the bicycle.

One end of the steel cord 12 is connected with a brake lever (not shown) of the bicycle. The other end of the steel cord 12 is connected with the other ends of the rocking arms 11. When pulling the brake lever of the bicycle, the steel cord 12 can drive the rocking arms 11 to reciprocally swing.

The frictional device 13 is disposed between the rocking arm 11 and the rim 15, including a rod body 32, a base seat 34 and a brake block 36.

One end of the rod body 32 is disposed on a middle portion of the rocking arm 11. The other end of the rod body 32 has a first connecting section 321.

The brake block 36 and a second connecting section 341 are respectively disposed on two opposite sides of the base seat 34. The second connecting section 341 is pivotally connected with the first connecting section 321.

According to the above structure, when pulling the brake lever of the bicycle, the steel cord 12 can drive the rocking arms 11 to make the frictional devices 13 get close to the rim 15. At this time, the brake blocks 36 can contact with the rim 15. The brake block 36 is connected with the base seat 34 and the base seat 34 is pivotally connected with the rod body 32. Therefore, when the brake block 36 suffers an action force of the rim 15, the brake block 36 can automatically swing by a certain angle. Accordingly, the brake block 36 can always contact with the rim 15 in an optimal mode.

The present invention has the following advantages:
1. The brake block 36 of the frictional device 13 can automatically swing so that the brake block 36 can always contact with the rim 15 in an optimal mode. Therefore, a stable and safe braking effect can be achieved.
2. The using life of the brake block 36 can be prolonged.

In the above structure, the first connecting section 321 of the rod body 32 further includes a first opening 3211 and a pin member 3212. The second connecting section 341 of the base seat 34 further includes a second opening 3411 and two pairs of recesses 3412.

The first opening 3211 is formed on the rod body 32.

The pin member 3212 is fitted through the first opening 3211.

The second opening 3411 is formed on the base seat 34 for accommodating one end of the rod body 32 having the first connecting section 321.

The two pairs of recesses 3412 are formed on the base seat 34 on two opposite sides of the second opening 3411. The bottom faces of each pair of recesses 3412 correspond to each other for accommodating two ends of the pin member 3212. Accordingly, the pin member 3212 is fitted through the first opening 3211 and the two pairs of recesses 3412 so as to pivotally connect the rod body 32 with the base seat 34.

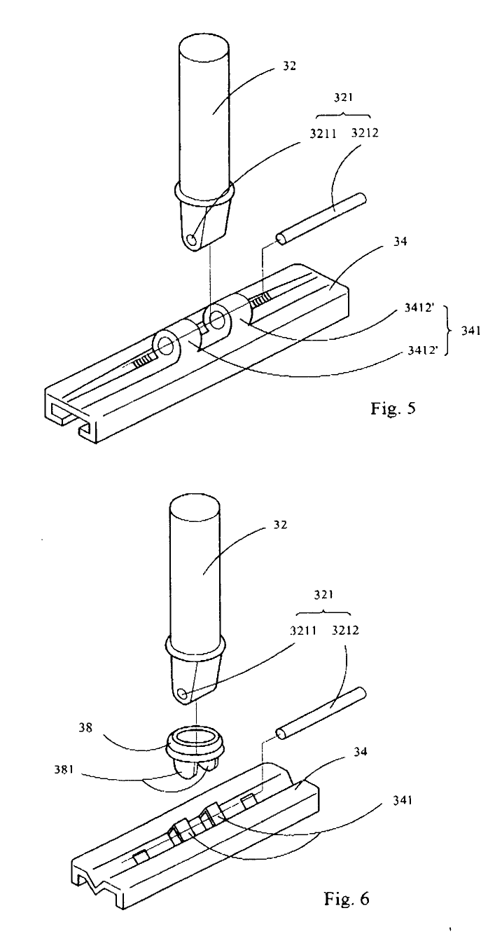

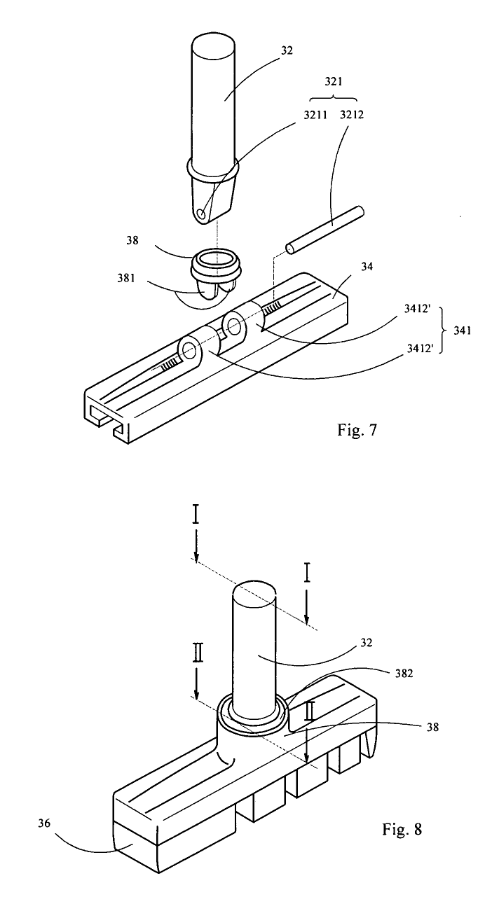

Please refer to FIG. 5. In the above structure, the second connecting section 341 is formed two correspondingly arranging rings 3412′ or two arranging polygonal bodies with two corresponding opening. The space between the two rings 3412′ accommodates one end of the rod body 32 having the first connecting section 321. Accordingly, the pin member 3212 is fitted through the first opening 3211 and the two rings 3412′ so as to pivotally connect the rod body 32 with the base seat 34.

Please refer to FIGS. 6 & 7. The above structure further includes a surrounding member 38 for enclosing the first connecting section 321 and the second connecting section 341 to make sure the first connecting section 321 and the second connecting section 341 pivotally connected. The surrounding member 38 can be an elastic material. Therefore, when there is no brake action, the base seat 34 can automatically restore a certain position to get an optimal using mode. The surrounding member 38 can be a sleeve with two protrusions 381 respectively corresponding to the two ends of the pin member 3212 to prevent the pin member 3212 from dropping.

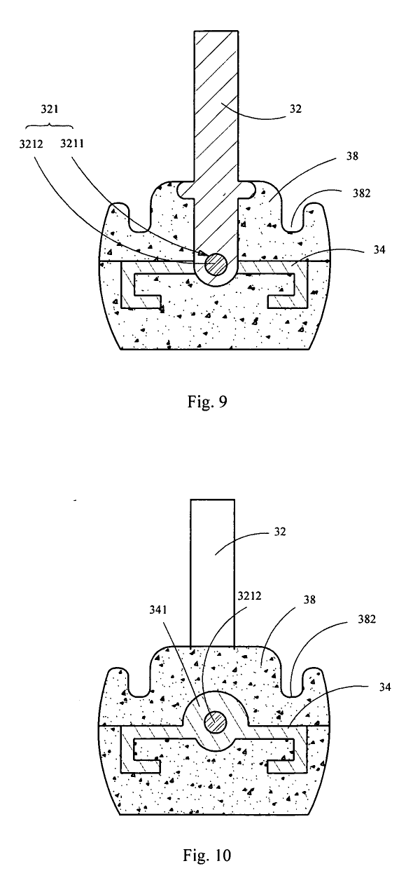

Please refer to FIGS. 8, 9 & 10. In the above structure, the surrounding member 38 can also encloses the first connecting section 321, the second connecting section 341 and the base seat 34. It can also get the function of the automatic swing and/or restoration. The portion of the surrounding member 38 surrounding the rod body 32 is arranged a concave 382 to make sure the brake block 36 automatically swung.

The above embodiments are only used to illustrate the present invention, not intended to limit the scope thereof. Many modifications of the above embodiments can be made without departing from the spirit of the present invention.

1. A brake structure capable of automatically swinging brake block, comprising:
two rocking arms, one end of each rocking arm being pivotally connected on a bicycle frame, the two rocking arms being oppositely positioned on two sides of a rim of the bicycle;
a steel cord, one end of the steel cord being connected with a brake lever of the bicycle, the other end of the steel cord being connected with the other ends of the rocking arms; and
two frictional devices respectively disposed between the rocking arms and the rim, each frictional device including a rod body, a base seat and a brake block, one end of the rod body being disposed on the rocking arm, the other end of the rod body having a first connecting section, the brake block and a second connecting section being respectively disposed on two opposite sides of the base seat, said brake structure being characterized in that the first connecting section is pivotally connected with the second connecting section.

2. The brake structure capable of automatically swinging the brake block as claimed in claim 1, wherein the first connecting section of the rod body includes a first opening and a pin member, the second connecting section of the base seat including a second opening and two pairs of recesses, the first opening being formed on the rod body, the pin member being fitted through the first opening, the second opening being formed on the base seat for accommodating one end of the rod body having the first connecting section, the two pairs of recesses being formed on the base seat on two opposite sides of the second opening, bottom faces of each pair of recesses corresponding to each other for accommodating two ends of the pin member, whereby the pin member is fitted through the first opening and the two pairs of recesses so as to pivotally connect the rod body with the base seat.

3. The brake structure capable of automatically swinging the brake block as claimed in claim 1, wherein the first connecting section of the rod body includes a first opening and a pin member, the second connecting section of the base seat including two correspondingly arranging rings being formed on the base seat, the first opening being formed on the rod body, the pin member being fitted through the first opening, the space between the two rings for accommodating one end of the rod body having the first connecting section, whereby the pin member is fitted through the first opening and the two rings so as to pivotally connect the rod body with the base seat.

4. The brake structure capable of automatically swinging the brake block as claimed in claim 1, further comprising a surrounding member for enclosing the first connecting section and the second connecting section.

5. The brake structure capable of automatically swinging the brake block as claimed in claim 2, further comprising a surrounding member for enclosing the first connecting section and the second connecting section.

6. The brake structure capable of automatically swinging the brake block as claimed in claim 3, further comprising a surrounding member for enclosing the first connecting section and the second connecting section.

7. The brake structure capable of automatically swinging the brake block as claimed in claim 4, wherein the surrounding member is an elastic material.

8. The brake structure capable of automatically swinging the brake block as claimed in claim 5, wherein the surrounding member is an elastic material.

9. The brake structure capable of automatically swinging the brake block as claimed in claim 6, wherein the surrounding member is an elastic material.

10. The brake structure capable of automatically swinging the brake block as claimed in claim 4, wherein the surrounding member is a sleeve.

11. The brake structure capable of automatically swinging the brake block as claimed in claim 5, wherein the surrounding member is a sleeve.

12. The brake structure capable of automatically swinging the brake block as claimed in claim 6, wherein the surrounding member is a sleeve.

13. The brake structure capable of automatically swinging the brake block as claimed in claim 7, wherein the surrounding member is a sleeve.

14. The brake structure capable of automatically swinging the brake block as claimed in claim 8, wherein the surrounding member is a sleeve.

15. The brake structure capable of automatically swinging the brake block as claimed in claim 9, wherein the surrounding member is a sleeve.

16. The brake structure capable of automatically swinging the brake block as claimed in claim 10, wherein the sleeve is disposed two protrusions respectively corresponding to the two ends of the pin member to prevent the pin member from dropping.

17. The brake structure capable of automatically swinging the brake block as claimed in claim 11, wherein the sleeve is disposed two protrusions respectively corresponding to the two ends of the pin member to prevent the pin member from dropping.

18. The brake structure capable of automatically swinging the brake block as claimed in claim 12, wherein the sleeve is disposed two protrusions respectively corresponding to the two ends of the pin member to prevent the pin member from dropping.

19. The brake structure capable of automatically swinging the brake block as claimed in claim 13, wherein the sleeve is disposed two protrusions respectively corresponding to the two ends of the pin member to prevent the pin member from dropping.

20. The brake structure capable of automatically swinging the brake block as claimed in claim 14, wherein the sleeve is disposed two protrusions respectively corresponding to the two ends of the pin member to prevent the pin member from dropping.

21. The brake structure capable of automatically swinging the brake block as claimed in claim 15, wherein the sleeve is disposed two protrusions respectively corresponding to the two ends of the pin member to prevent the pin member from dropping.

22. The brake structure capable of automatically swinging the brake block as claimed in claim 1, further comprising a surrounding member for enclosing the first connecting section, the second connecting section and the base seat.

23. The brake structure capable of automatically swinging the brake block as claimed in claim 2, further comprising a surrounding member for enclosing the first connecting section, the second connecting section and the base seat.

24. The brake structure capable of automatically swinging the brake block as claimed in claim 3, further comprising a surrounding member for enclosing the first connecting section, the second connecting section and the base seat.

25. The brake structure capable of automatically swinging the brake block as claimed in claim 22, wherein the surrounding member is an elastic material.

26. The brake structure capable of automatically swinging the brake block as claimed in claim 23, wherein the surrounding member is an elastic material.

27. The brake structure capable of automatically swinging the brake block as claimed in claim 24, wherein the surrounding member is an elastic material.

28. The brake structure capable of automatically swinging the brake block as claimed in claim 22, wherein the portion of the surrounding member surrounding the rod body is disposed a concave to make sure the brake block automatically swung.

29. The brake structure capable of automatically swinging the brake block as claimed in claim 23, wherein the portion of the surrounding member surrounding the rod body is disposed a concave to make sure the brake block automatically swung.

30. The brake structure capable of automatically swinging the brake block as claimed in claim 24, wherein the portion of the surrounding member surrounding the rod body is disposed a concave to make sure the brake block automatically swung.

31. The brake structure capable of automatically swinging the brake block as claimed in claim 25, wherein the portion of the surrounding member surrounding the rod body is disposed a concave to make sure the brake block automatically swung.

32. The brake structure capable of automatically swinging the brake block as claimed in claim 26, wherein the portion of the surrounding member surrounding the rod body is disposed a concave to make sure the brake block automatically swung.

33. The brake structure capable of automatically swinging the brake block as claimed in claim 27, wherein the portion of the surrounding member surrounding the rod body is disposed a concave to make sure the brake block automatically swung.
